(19) United States
(12) Patent Application Publication
(10) Pub. No.: US 2021/0018103 A1
(43) Pub. Date: Jan. 21, 2021

(54) DIAPHRAGM VALVE

(71) Applicant: FUJIKIN INCORPORATED, Osaka-shi (JP)

(72) Inventors: Tadayuki Yakushijin, Osaka-shi (JP); Keisuke Ishibashi, Osaka-shi (JP); Michio Yamaji, Osaka-shi (JP); Akihiro Harada, Osaka-shi (JP)

(73) Assignee: FUJIKIN INCORPORATED, Osaka-shi (JP)

(21) Appl. No.: 17/043,025

(22) PCT Filed: Sep. 17, 2019
(86) PCT No.: PCT/JP2019/036267

§ 371 Date: Sep. 29, 2020

(30) Foreign Application Priority Data
Sep. 26, 2018 (JP) 2018-179889

(51) Int. Cl. F16K 7/16; F16K 7/17

(52) U.S. Cl. CPC F16K 7/16; F16K 7/17

(57) ABSTRACT

A diaphragm valve configured to allow for adjustment of a Cv value during assembly of the diaphragm valve is provided. A valve body, a diaphragm, an actuator, a bonnet, a stem, and a diaphragm holder are provided, the bonnet includes a through hole coaxial with the stem and formed with a female thread, the cylindrical body formed with a male thread on an outer surface is screwed into the through hole in engagement with the female thread, the stem is inserted into the cylindrical body, a diaphragm side end surface of the cylindrical body protrudes from an opening surface of the through hole on the diaphragm side toward a diaphragm, a stem side end surface of the diaphragm holder comes into abutment with the diaphragm side end surface of the cylindrical body, so that a position of the abutted surfaces in an axial direction of the stem is adjusted by a degree of adjustment between the male thread and the female thread.

### TECHNICAL FIELD

The present invention relates to a diaphragm valve and a method of adjusting a Cv value of the diaphragm valve.

### BACKGROUND ART

Valves such as ball valves are used in a number of product fields such as manufacturing apparatuses, plant apparatuses, and inspection devices as a device for controlling fluid flow.

A valve includes a valve body having a communicating part which communicates an inlet flow path and an outlet flow path, and a valve element disposed at the communicating part. The valve element is driven by a handle provided at an upper part thereof in a case of a manually operating valve and by a motor or the like in the case of an automatic valve, and a joint member referred to as a stem is interposed between the handle or the motor or the like and the valve element.

For example, an automatic diaphragm valve (see FIG. 12) disclosed in Patent Literature 1 employs a diaphragm valve 50 which is referred to as a direct-touch type metallic diaphragm valve, including: a valve body 52 having a fluid inflow passage 52a and a fluid outflow passage 52b; a casing 54 mounted above the valve body 52 via a bonnet 53; an annular valve seat 55 provided on a peripheral edge of the fluid inflow passage 52a; a metallic diaphragm 56 configured to open and close the fluid inflow passage 52a by being pushed against, or retracted away from, the annular valve seat 55; a holding adapter 65 configured to secure the diaphragm 56; a diaphragm holder 57 configured to press the diaphragm 56 downward; a stem 58 disposed in a casing 54 and configured to move the diaphragm 56 in an opening or closing direction by being moved upward or downward; upper and lower pistons 59, 60; a compression coil spring (biasing member) 61; and a mechanism for introducing operation air for driving the upper and lower pistons 59, 60.

In order to move the stem 58 upward, the operation air is caused to act on the respective pistons 59 and 60. For this purpose, an upper operation air introduction chamber 79 and a lower operation air introduction chamber 80 are formed below the pistons 59, 60 respectively. The upper and lower pistons 59, 60 are formed with an axial passage 59a and radial passages 59b, 60b for sending the introduced operation air to the respective operation air introduction chambers 79, 80. The operation air is introduced into the respective operation air introduction chambers 79, 80, thereby applying an upward force to the respective pistons 59, 60. A counter plate 76 is interposed between the pistons 59 and 60.

### CITATION LIST

### Patent Literature

PTL 1: JP-A-2016-161022

### SUMMARY OF INVENTION

### Technical Problem

When the diaphragm holder 57 moves to an uppermost position and thus does not press the diaphragm 56, a fully opened state is achieved. An amount of fluid flowing in this state relates to a capacitive coefficient of the valve, which is referred to as a Cv value. According to JIS standard, the Cv value is a flow rate value indicating a flow rate of freshwater at a temperature of 60 degrees F. flowing through the valve with a pressure difference of 1 Psi within a specific operation range, which is expressed by US gallon/min. The Cv value is proportional to an opening area where the fluid flows with the valve fully opened, and thus an adequate combination of components is required in order to minimize variation of the Cv value among the same products.

Components which may affect the opening area where the fluid flows with the valve fully opened in the diaphragm valve 50 of the related art illustrated in FIG. 12 include, for example, the valve body 52, the annular valve seat 55, the diaphragm 56, the holding adapter 65, and the diaphragm holder 57, and therefore, manufacturing a diaphragm valve with least variation in Cv value with variations in dimensions of these components taken into consideration is significantly time-consuming and troublesome work. In addition, in order to adjust the Cv value, since the Cv value cannot be measured unless a fluid is actually flowed, it seems to be impossible to incorporate a step of positively adjusting the Cv value in a step of assembling a diaphragm valve. Therefore, a method of assembling the components with dimensions of components taken into consideration has been employed for a long time in the related art. In addition, when an actuator in the casing 54 encounters a failure, the bonnet 53 as a whole needs to be removed from the valve body 52, which results in exposure of the fluid flowing in a flow path to the outside air.

It is an object of the present invention to provide a diaphragm valve configured to allow for adjustment of a Cv value during assembly of the diaphragm valve, and a method of adjusting the Cv value.

### Solution to Problem

The present invention (1) provides a diaphragm valve including: a valve body provided with a fluid flow path; a diaphragm configured to open and close the fluid flow path; an actuator configured to press the diaphragm; a bonnet interposed between the valve body and a casing of the actuator; a stem moved by the actuator; and a diaphragm holder disposed between the stem and the diaphragm and including an outer edge having a diameter larger than an outer diameter of the stem, in which the bonnet includes a through hole coaxial with the stem and formed with a female thread, the through hole accommodates a cylindrical body screwed therein, the cylindrical body having a male thread formed on an outer surface thereof for engaging the female thread, the stem is inserted into the cylindrical body, the cylindrical body has a diaphragm-side end surface protruding from a diagram-side opening surface of the through hole toward the diaphragm, a stem-side end surface of the diaphragm holder at an outer edge thereof and the diaphragm-side end surface of the cylindrical body are in abutment with each other, the position of the abutted surfaces in a direction of a stem axis are allowed to be adjusted by a degree of engagement between the male thread and the female thread.

In the present invention (1), the cylindrical body is provided as a Cv value adjustment member which is not provided on the diaphragm valve in the related art. The cylindrical body is formed with the male thread, which is to be engaged with the female thread formed in an interior of the bonnet, on an outer peripheral surface. The stem is inserted into the cylindrical body, and the diaphragm holder is disposed between the stem and the diaphragm. Once the bonnet is secured to the valve body, even when a fluid is flowed therethrough, the fluid is prevented from leaking out. Since the diaphragm-side end surface of the cylindrical body and the stem-side end surface of the diaphragm holder at the outer edge thereof are brought into abutment with each other, and the position of a plane of abutment may be adjusted by adjusting the degree of engagement between the male thread and the female thread, precise adjustment of the Cv value is achieved by assembling the diaphragm valve in association with such adjustment.

The present invention (2) is the valve of the present invention (1) characterized in that the bonnet is provided with a recess on an upper part thereof; the cylindrical body is provided at an upper part thereof with a cylindrical body flange having a diameter larger than the male thread and smaller than an inner diameter of the recess, and the cylindrical body flange is secured to a bottom surface of the recess by screw means.

As the Cv value is determined by the degree of engagement between the male thread and the female thread, if the cylindrical body rotates with respect to the bonnet, the Cv value changes correspondingly. In order to avoid such an event, the cylindrical body flange is secured to the bottom surface of the recess by the screw means to prevent an occurrence of changes in the Cv value after assembly.

The present invention (3) is the diaphragm valve according to the present invention (1), characterized in that the actuator is secured to the bonnet or the valve body with a diaphragm-side end surface of the actuator pressing an actuator-side end surface of the cylindrical body.

In the same manner as the present invention (2), the present invention (3) is devised to prevent changes in the Cv value after assembly of the diaphragm valve. With the configuration in which the diaphragm-side end surface of the actuator presses the actuator-side end surface of the cylindrical body to cause the actuator to be secured to the bonnet or the valve body, the occurrence of changes in the Cv value after assembly may be prevented.

The present invention (4) is a method of adjusting a Cv value of a diaphragm valve including: a step of placing a diaphragm configured to open and close a fluid flow path on a valve body provided with the fluid flow path, placing a holding adapter configured to press and hold an outer peripheral edge of the diaphragm on a valve body side on the diaphragm, and placing a stem configured to deform the diaphragm in an opening or closing direction on the diaphragm, the stem including, at a lower end portion thereof, a diaphragm holder having an outer edge with a diameter larger than an outer diameter of the stem; a step of screwing a male thread formed on an outer peripheral surface of a cylindrical-shaped cylindrical body into engagement with a female thread formed on an inner peripheral surface of the cylindrical-shaped bonnet to accommodate the cylindrical body in the interior of the bonnet; a step of inserting the stem in the cylindrical body, attaching the bonnet in which the cylindrical body is accommodated to the valve body, and pressing the holding adapter with a diaphragm-side end surface of the bonnet to secure the diaphragm to the valve body; a step of flowing a fluid into the fluid flow path and measure a Cv value; a step of bringing the diaphragm-side end surface of the cylindrical body into abutment with the stem side end surface of the diaphragm holder at the outer edge thereof; a step of repeating changing a degree of engagement between the male thread and the female thread, flowing a fluid through the fluid flow path, and measuring the Cv value until a target Cv value is achieved; and a step of securing the cylindrical body to the bonnet after the Cv value is adjusted to the target Cv value of the diaphragm valve.

A lower end surface of the bonnet presses an upper end surface of the holding adapter, so that the diaphragm is secured to the valve body. Accordingly, even when a fluid is flowed through the fluid flow path, the fluid is prevented from leaking out.

Before the diaphragm is secured to the valve body, the stem having the diaphragm holder at the lower end portion thereof is placed on the diaphragm without pressing the diaphragm, the stem is inserted through the interior of the cylindrical body, and the cylindrical body is accommodated in the interior of the bonnet by means of engagement or the like.

In a state in which hermeticity in the flow path is maintained, a fluid is flowed in a fully opened state, which corresponds to a state in which no pressing force is applied to the diaphragm, and the Cv value is measured. The Cv value at the initial measurement is preferably set to be slightly larger than the target Cv value. After the diaphragm-side end surface of the cylindrical body is brought into abutment with a stem-side end surface of the holding adapter, the degree of engagement between the female thread formed on the inner peripheral surface of the bonnet and the male thread formed on the outer peripheral surface of the cylindrical-shaped cylindrical body is adjusted in view of the result of measurement of the Cv value. When the position of a plane of abutment between the diaphragm-side end surface of the cylindrical body and the stem-side end surface of the diaphragm holder is moved toward the diaphragm, the position of the contact surface of the diaphragm holder with the diaphragm is lowered and thus the diaphragm is deflected, so that the Cv value is reduced. Repeating these procedures may results in the Cv value closer to the target value.

### Advantageous Effect of Invention

According to the diaphragm valve of the present invention, the Cv value closer to the target Cv value is achieved without selecting members during assembly, and manufacture of diaphragm valve with less variation in the Cv value is achieved. In addition, even when the actuator encounters a failure, for example, removal of the bonnet from the valve body is not necessary, and thus the fluid in the flow path is not exposed to the outside air.

### BRIEF DESCRIPTION OF DRAWINGS

FIG. 1 illustrates a diaphragm valve of Example 1 according to the present invention in a fully opened state.

FIG. 2 illustrates the diaphragm valve of Example 1 in a fully closed state.

FIG. 3 illustrates a state before a cylindrical body is set in a course of assembly of the diaphragm valve of Example 1.

FIG. 4 illustrates a state after the cylindrical body is set in the course of assembly of the diaphragm valve of Example 1.

FIG. 5 is a perspective view of the cylindrical body used in the diaphragm valve of Example 1.

FIG. 6 is a cross-sectional view of an adjustment jig for rotating the cylindrical body.

FIG. 7 illustrates a diaphragm valve of Example 2 according to the present invention in a fully opened state.

FIG. 8 illustrates the diaphragm valve of Example 2 in a fully closed state.

FIG. 9 illustrates a state before a stem is inserted into a cylindrical body in a course of assembly of the diaphragm valve of Example 2.

FIG. 10 illustrates a state after a holding adapter is secured to a valve body and the stem is inserted into the cylindrical body in the course of assembly of the diaphragm valve of Example 2.

FIG. 11 illustrates a state before a Cv value of the diaphragm valve of Example 2 is adjusted and an actuator is connected to a bonnet.

FIG. 12 is a cross-sectional view of a diaphragm valve of the related art disclosed in Patent Literature 1.

### DESCRIPTION OF EMBODIMENTS

Referring now to the drawings, a detailed description of preferable examples of the present invention will be given below illustratively. Note that shapes, relative layouts, and the like of components described in these examples are illustrative only without limiting the scope of the invention unless otherwise specifically noted. Likewise, directions of the members may be referred to as up(per), low(er), left and right depending on the directions on the drawings for the sake of convenience, these terms are not intended to limit the scope of the present invention.

### Embodiment 1

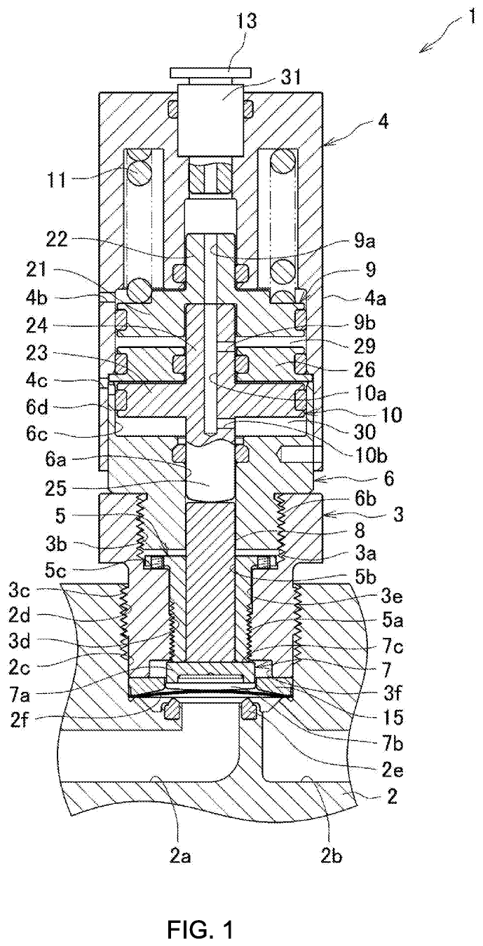

FIG. 1 illustrates a fully opened state of a diaphragm valve of Example 1 according to the present invention. The diaphragm valve includes three components; a valve body 2, an actuator 4, and a bonnet 3 provided therebetween.

The diaphragm valve 1 includes a valve body 2 including a fluid inflow passage 2a and a fluid outflow passage 2b; an actuator 4 mounted above the valve body 2 via a bonnet 3; an annular valve seat 2e provided on a peripheral edge of a fluid inflow passage 2a; a metallic diaphragm 2f configured to open and close the fluid flow path by being pushed against, or retracted away from, the annular valve seat 2e; a diaphragm holder 7 configured to press the diaphragm 2f downward; a compression coil spring (biasing member) 11; and a stem 8 configured to be moved downward by a pressing force of the compression coil spring 11 and moved upward by supplying a working fluid (hereinafter simply referred to as “operation air”) to the actuator 4 to move the diaphragm 2f in opening or closing direction; upper and lower pistons 9, 10; and drive means 13 configured to drive the upper and lower pistons 9,10. Note that the fluid inflow passage 2a and the fluid outflow passage 2b may work in an opposite way in terms of inflow and outflow.

The diaphragm 2f has an upwardly protruding arcuate shape which is formed into a spherical shell shape in a natural state. The diaphragm 2f is formed of, for example, a nickel alloy sheet and is formed into a spherical shell shape by cutting out the plate into a circular shape and making a center portion swelled upward. The diaphragm 2f may be formed of a stainless steel sheet or of a laminated body made of a stainless steel sheet and nickel-cobalt alloy sheet.

A holding adapter 15 is disposed between a lower end surface of the bonnet 3 and a bottom surface of the valve body recess 2c of the valve body 2, and an outer peripheral edge of the diaphragm 2f is retained between the holding adapter 15 and the bottom surface of the valve body recess 2c of the valve body 2 and is secured by screwing the bonnet 3 inward.

The upper piston 9 includes a disc-shaped piston body 21 and a protruding shaft portion 22 extending upward from an upper surface of a center portion of the piston body 21. The lower piston 10 includes a disc-shaped piston body 23, an upper protruding shaft portion 24 extending upward from an upper surface of a center portion of the piston body 23, and a lower protruding shaft portion 25 extending downward from a lower surface of the center portion of the piston body 23.

A counter plate 26 is fixed so as to be positioned between the upper piston 9 and the lower piston 10, whereby spaces of movement of the pistons 9, 10 are defined above and below the counter plate 26, respectively.

An upper end portion of the upper protruding shaft portion 24 of the lower piston 10 is fitted into a recess provided on a lower surface of the piston body 21 of the upper piston 9. A compression coil spring 11 is provided so as to urge the upper piston 9 downward, whereby the upper and lower pistons 9, 10 are moved integrally upward and downward.

The actuator 4 is principally accommodated in an interior of a casing 4a and is connected to the drive means 13 via a one-touch joint 31. The drive means 13 is configured to cause the operation air to act on the respective pistons 9, 10 for moving the stem 8 upward, and the upper operation air introduction chamber 29 and a lower operation air introduction chamber 30 therefor are formed below the respective pistons 9, 10. The upper and lower pistons 9, 10 are formed with axial passages 9a, 10b and radial passages 9b, 10b for sending operation air introduced via the one-touch joint 31 to the respective operation air introduction chambers 29, 30. The operation air is introduced into the respective operation air introduction chambers 29, 30, thereby applying an upward force to the respective pistons 9, 10. In addition, exhaust ports 4b, 4c for releasing air in the respective operation air introduction chambers 29, 30 are provided in the casing 4a.

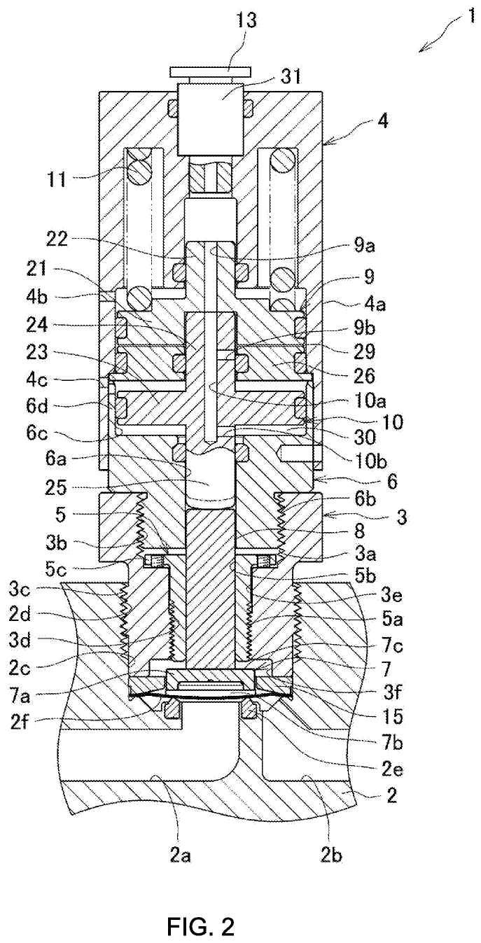

In a state in which the operation air is not introduced into the respective operation air introduction chambers 29, 30, the stem 8 is in the closed position (see FIG. 2) due to a biasing force of the compression coil spring 11, while when the operating air is introduced into the respective operation air introduction chambers 29, 30, the stem 8 is moved upward against the biasing force of the compression coil spring 11, so that an opened state, in which the diaphragm holder 7 is moved upward and the diaphragm 2f is deformed into a protruding shape, is achieved. FIG. 1 illustrates a fully opened state.

A joint member 6 is provided at a lower part of the actuator 4 as a part of the actuator 4 and is formed at an upper part thereof with a joint member recess 6c surrounded by a joint member upright wall 6d, and the piston body 23 is accommodated in the joint member recess 6c. The joint member 6 is formed with a joint member through hole 6a at a center thereof, and the lower protruding shaft portion 25 and the stem 8 are inserted into the joint member through hole 6a from above and from below, respectively, and a lower end of the lower protruding shaft portion 25 and an upper end of the stem 8 are capable of coming into and out of contact with each other in the joint member through hole 6a. The actuator 4 and the joint member 6 are secured by forming threads on an outer peripheral surface of the joint member upright wall 6d and an inner peripheral surface of a lower part of the actuator 4, screwing these threads into engagement with each other, and then fastening with fastening member such as a bolt from a side surface, or applying securing means such as welding.

The actuator 4 described above has a configuration of a so-called normally-closed type, which presses the diaphragm 2f to close the flow path when the operation air is not introduced. However, an actuator of a so-called normally-open type, which has the compression coil spring 11 on the diaphragm 2f side, presses the piston 23 away from the diaphragm to prevent the diaphragm 2f from being pressed when the operation air is not introduced, is also applicable.

A joint member male thread 6b is formed on a lower outer peripheral surface of the joint member 6, and the joint member male thread 6b is screwed into engagement with a bonnet upper female thread 3b formed on a side surface of a bonnet upper recess 3a on an upper part of the bonnet 3, so that the actuator 4 and the bonnet 3 are connected. By screwing a bonnet male thread 3c formed on the outer peripheral surface of the bonnet 3 and the valve body female thread 2d into engagement, the bonnet 3 is connected to the valve body 2.

The lower end of the stem 8 is provided with the diaphragm holder 7 having a diameter larger than the outer diameter of the stem 8, and an abutting part 7b is provided at a lower end portion of the diaphragm holder 7. The amount of upward movement of the stem 8 and the Cv value have a correlative relationship, and thus adjustment of the amount of upward movement of the stem is required for achieving a required Cv value.

The bonnet 3 is formed with a bonnet through hole 3e at a center thereof, and the cylindrical body 5 is inserted into the through hole 3e. The cylindrical body 5 is a Cv value adjusting member, which is the most important component of the present invention. A cylindrical body male thread 5a is formed on a lower outer periphery of the cylindrical body 5, and the cylindrical body male thread 5a is screwed into engagement with the bonnet lower female thread 3d.

The cylindrical body 5 is formed with a cylindrical through hole 5b, and the stem 8 is inserted into the interior of the cylindrical through hole 5b. The diaphragm holder 7 is attached to the lower end portion of the stem 8. The diaphragm holder 7 may be formed integrally with the stem 8. The diaphragm holder 7 is partly accommodated in a bonnet lower recess 3f. An outer edge portion 7a of the diaphragm holder 7 is in abutment with the lower end surface of the cylindrical body 5 at an upper surface 7c of the outer edge portion thereof. Accordingly, the Cv value can be adjusted by a vertical position of the abutted surfaces.

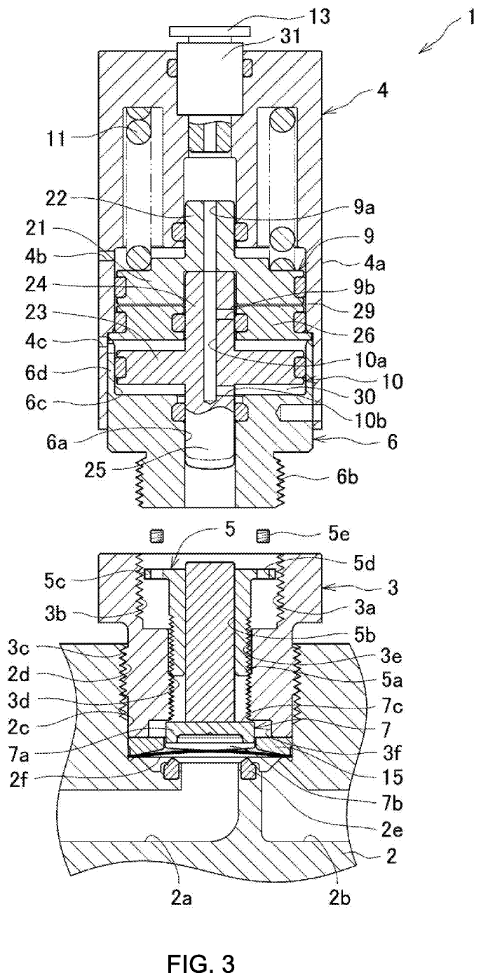

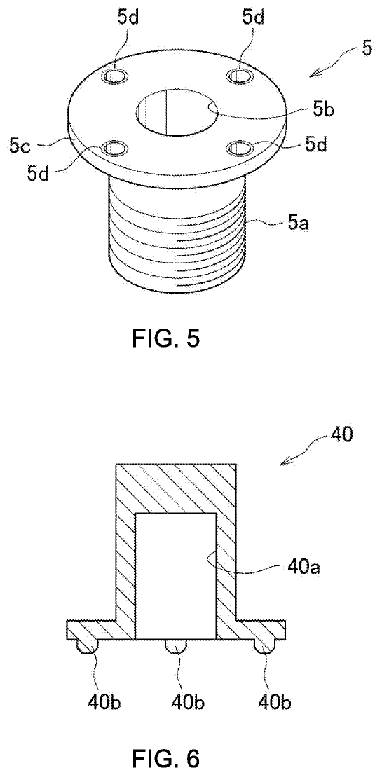

A cylindrical body flange 5c is formed on an upper part of the cylindrical body 5, and the cylindrical body flange 5c is secured to a bottom surface of the bonnet upper recess 3a by screw means (see FIGS. 3, 5).

FIG. 2 illustrates a state in which the diaphragm valve of Example 1 illustrated in FIG. 1 is changed from the fully opened state to the fully closed state. From FIG. 2 onward, the same description as FIG. 1 will be omitted. Air is released from the operation air introduction chambers 29, 30, and the pistons 9, 10 are pressed downward by a biasing force by the compression coil spring 11, so that the stem 8 is also pressed downward, and the diaphragm 2f is deformed as illustrated in FIG. 2 and comes into abutment with the annular valve seat 2e to achieve the fully closed state.

FIG. 3 illustrates a state before a cylindrical body 5 is set in the course of assembly of the diaphragm valve 1 of Example 1. Illustrated are female threads 5d formed in the cylindrical body flange 5c, and setscrews 5e to engage the female thread 5d. The state illustrated in FIG. 3, that is, in a state in which no pressing force is loaded on the diaphragm 2f, a fluid is flowed from the fluid inflow passage 2a to the fluid outflow passage 2b and the Cv value is measured. In this state, for example, when a desired Cv value required for shipping is 3.0, dimensions of the component are adjusted to achieve a value slightly larger than that value, for example, on the order of 3.2.

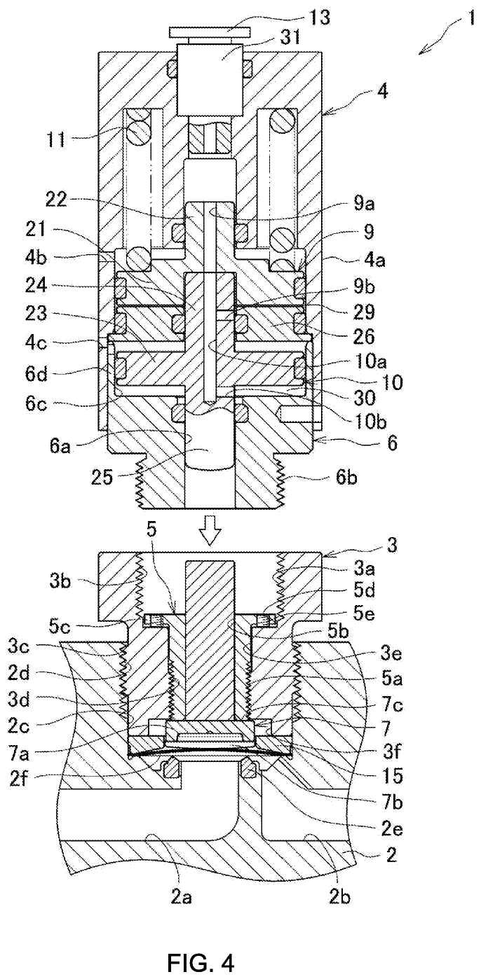

Next, the cylindrical body 5 is set as illustrated in FIG. 4, the screws are adjusted so that the lower end surface of the cylindrical body 4 moves the outer edge upper surface 7c, which corresponds to an upper end surface of the outer edge 7a of the diaphragm holder 7, downward, and then a fluid is flowed to measure the Cv value. By achieving a target value 3.0, the adjustment is completed. When the value is assumed to be 3.1, the adjustment is performed again and then the Cv value is measured. It is also possible to adjust the Cv value to a desired value by rotationally moving the cylindrical body 5 little by little in a state in which the fluid is flowing. In this manner, the Cv value can be adjusted to fall within an allowable range of a target value. After the adjustment of the Cv value, the setscrews 5e may be screwed into engagement with the female threads 5d to secure the cylindrical body flange 5c to the bottom surface of the bonnet upper recess 3a, thereby preventing the cylindrical body 5 from rotating after assembly. When the setscrews 5e are screwed in, a force is applied to the cylindrical body 5 to a direction opposite from the diaphragm side, so that the Cv value is slightly lowered. Therefore, in the adjustment described above, it is preferable to take changes in the Cv value generated when the setscrews 5e is secured by screw engagement into consideration in adjustment. Note that the female threads 5d are formed at four positions in the cylindrical body flange 5c at regular intervals as illustrated in the drawings but may be formed at two positions.

FIG. 5 illustrates a perspective view of the cylindrical body 5 used in the diaphragm valve of Example 1.

FIG. 6 illustrates a cross-sectional view of an adjustment jig 40 for rotating the cylindrical body 5 to adjust the Cv value. The adjustment jig 40 is formed with an adjustment jig recess 40a in which an upper part of the stem 8 is inserted, and four protrusions 40b on a lower end surface. The protrusions 40 are inserted into the female threads 5d and caught therein, so that the cylindrical body 5 can be rotated.

### Embodiment 2

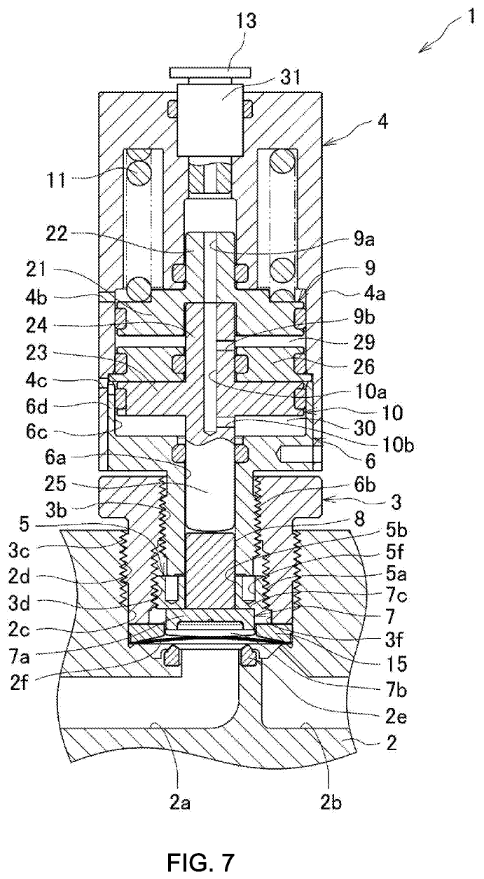

FIG. 7 illustrates a fully-opened state of a diaphragm valve of Example 2 according to the present invention. A point different from Example 1 in FIG. 1 is a shape of the cylindrical body 5 and how to fix the cylindrical body 5. In this example, the cylindrical body 5 has no cylindrical body flange 5c, which was present in Example 1. The upper surface of the cylindrical body 5 is pressed by the lower end surface of the joint member 6, and thus the rotation is prevented. In this example, the actuator 4 is secured by the lower end surface of the joint member 6, which is formed integrally with the actuator 4, coming into abutment with the cylindrical body 5. However, in Example 1, the lower end surface of the joint member 6 is secured by the actuator 4 in abutment with the upper end surface of the bonnet 3, but not in abutment with the cylindrical body 5. In addition, in this example, the cylindrical body 5 is prevented from rotating in association with the lower end surface of the joint member 6 by forming the threads of the cylindrical body male thread 5a and the bonnet lower female thread 3d in an inverse direction from the threads of the joint member male thread 6b of the joint member 6 and the bonnet upper female thread 3b.

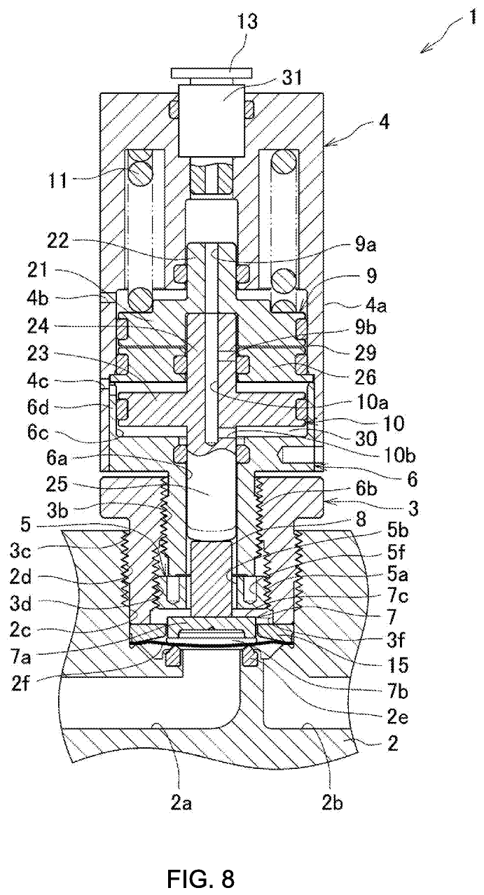

FIG. 8 illustrates a fully closed state of the diaphragm valve of Example 2, and movement changing from fully open to fully close is the same as the description in conjunction with FIG. 2.

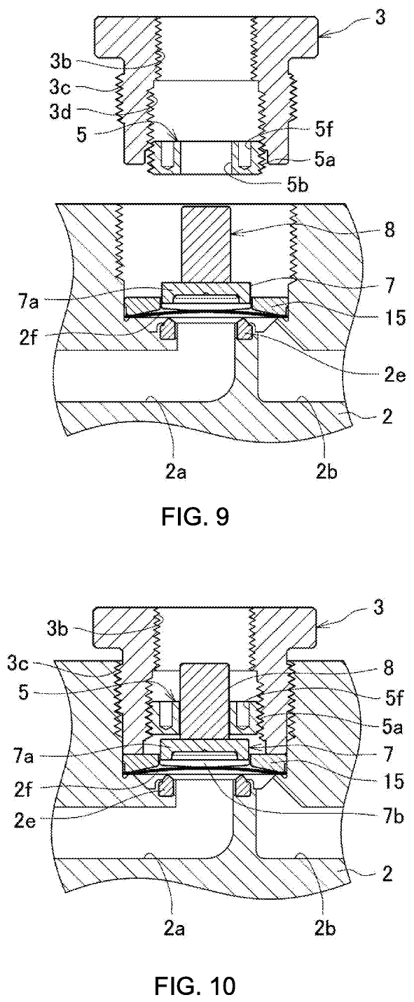

FIG. 9 illustrates a state before the stem 8 is inserted into the cylindrical body 5 in the course of assembly of the diaphragm valve 1 of Example 2. In this state, a fluid cannot be flowed because leakage occurs if the fluid is flowed therein.

FIG. 10 illustrates a state after the holding adapter 15 is secured to the valve body 2 and the stem 8 is inserted into the cylindrical body 5 in the course of assembly of the diaphragm valve 1 of Example 2. In this state, the fluid can be flowed because no leakage occurs. The fluid is flowed from the fluid inflow passage 2a to the fluid outflow passage 2b in the state in FIG. 10, and the Cv value is measured. In this state, for example, when a desired Cv value required for shipping is 3.0, dimensions of the component are adjusted to achieve a value slightly larger than that value, for example, on the order of 3.2, in the same manner as Example 1.

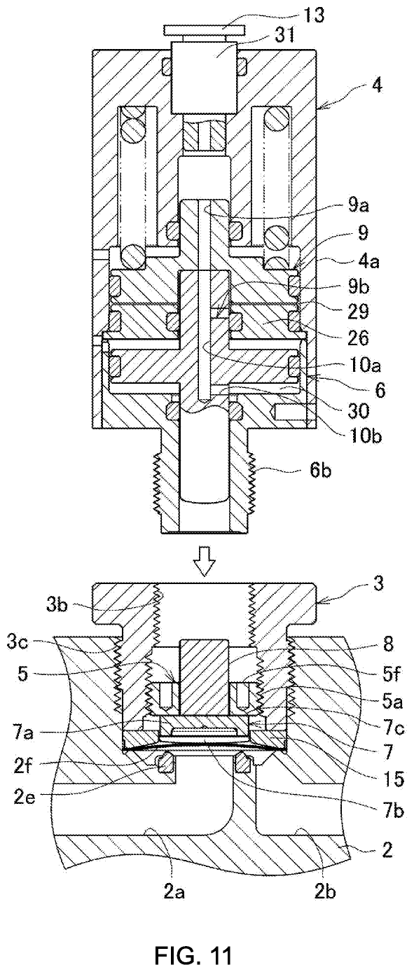

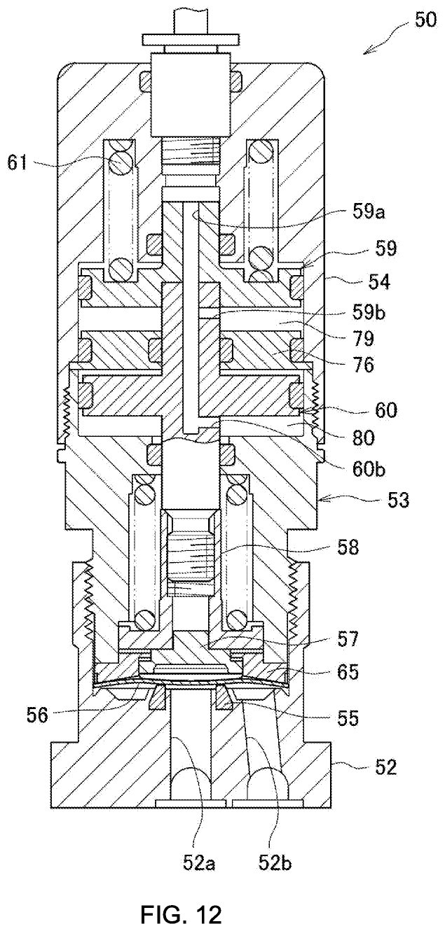

Next, the cylindrical body 5 is adjusted by screws as illustrated in FIG. 11 so that the lower end surface of the cylindrical body 5 moves the outer edge upper surface 7c, which corresponds to an upper end surface of the outer edge 7a of the diaphragm holder 7, downward, then a fluid is flowed to measure the Cv value. When achieving the target value 3.0, the adjustment is completed. When the value is assumed to be 3.1, the adjustment is performed again and then the Cv value is measured. In this case, it is also possible to adjust the Cv value to a desired value by rotationally moving the cylindrical body 5 little by little in a state in which the fluid is flowing in the same manner as in Example 1. In this manner, the Cv value can be adjusted to fall within an allowable range of a target value. After the Cv value is adjusted, the joint member male thread 6b is screwed into engagement with the bonnet upper female thread 3b so that the lower end surface of the joint member 6 presses the upper end surface of the cylindrical body 5 to prevent movement of the cylindrical body 5. In this manner, the rotation of the cylindrical body 5 after assembly of the diaphragm valve can be prevented.

### REFERENCE SIGNS LIST

1; diaphragm valve
2; valve body
2a; fluid inflow passage
2b; fluid outflow passage
2c; valve body recess
2d; valve body female thread
2e; annular valve seat
2f; diaphragm
3; bonnet
3a; bonnet upper recess
3b; bonnet upper female thread
3c; bonnet male thread
3e; bonnet through hole
3d; bonnet lower female thread
3f; bonnet lower recess
4; actuator
4a; casing
4b; exhaust port
4c; exhaust port
5; cylindrical body
5a; cylindrical body male thread
5b; cylindrical body through hole
5c; cylindrical body flange
6; joint member
6a; joint member through hole
6b; joint member male thread
6c; joint member recess
6d; joint member upright wall
7; diaphragm holder
7a; outer edge
7b; abutting part
7c; outer edge upper surface
8; stem
9; piston
9a; axial passage
9b; radial passage
10; piston
10a; axial passage
10b; radial passage
11; compression coil spring
13; drive means
15; holding adapter
21; piston body
22; protruding shaft portion
23; piston body
24; upper protruding shaft portion
25; lower protruding shaft portion
26; counter plate
29; operation air introduction chamber
30; operation air introduction chamber
31; one-touch joint

1. A diaphragm valve comprising:
a valve body provided with a fluid flow path;
a diaphragm configured to open and close the fluid flow path;
an actuator configured to press the diaphragm;
a bonnet interposed between the valve body and a casing of the actuator;
a stem moved by the actuator; and
a diaphragm holder disposed between the stem and the diaphragm and including an outer edge having a diameter larger than an outer diameter of the stem, wherein
the bonnet includes a through hole coaxial with the stem and formed with a female thread,
the through hole accommodates a cylindrical body screwed therein, the cylindrical body having a male thread formed on an outer surface thereof for engaging the female thread,
the stem is inserted into the cylindrical body,
the cylindrical body has a diaphragm-side end surface protruding from a diagram-side opening surface of the through hole toward the diaphragm,
a stem-side end surface of the diaphragm holder at an outer edge thereof and the diaphragm-side end surface of the cylindrical body are in abutment with each other, so that the position of the abutted surfaces in a direction of a stem axis are allowed to be adjusted by a degree of engagement between the male thread and the female thread.

2. The diaphragm valve according to claim 1, wherein
the bonnet is provided with a recess on an upper part thereof;
the cylindrical body is provided at an upper part thereof with a cylindrical body flange having a diameter larger than the male thread and smaller than an inner diameter of the recess, and
the cylindrical body flange is secured to a bottom surface of the recess by screw means.

3. The diaphragm valve according to claim 1, wherein the actuator is secured to the bonnet or the valve body with a diaphragm-side end surface of the actuator pressing an actuator-side end surface of the cylindrical body.

4. A method of adjusting a Cv value of a diaphragm valve comprising:
a step of placing a diaphragm configured to open and close a fluid flow path on a valve body provided with the fluid flow path, placing a holding adapter configured to press and hold an outer peripheral edge of the diaphragm on a valve body side on the diaphragm, and placing a stem configured to deform the diaphragm in an opening or closing direction on the diaphragm, the stem including, at a lower end portion thereof, a diaphragm holder having an outer edge with a diameter larger than an outer diameter of the stem,
a step of screwing a male thread formed on an outer peripheral surface of a cylindrical body into engagement with a female thread formed on an inner peripheral surface of the cylindrical-shaped bonnet to accommodate the cylindrical body in an interior of the bonnet;
a step of inserting the stem in the cylindrical body, attaching the bonnet in which the cylindrical body is accommodated to the valve body, and pressing the holding adapter with a diaphragm-side end surface of the bonnet to secure the diaphragm to the valve body;
a step of flowing a fluid into the fluid passage and measure a Cv value;
a step of bringing the diaphragm-side end surface of the cylindrical body into abutment with the stem side end surface of the outer edge of the diaphragm holder;
a step of repeating changing a degree of engagement between the male thread and the female thread, flowing a fluid through the fluid flow path, and measuring the Cv value until a target Cv value is achieved; and
a step of securing the cylindrical body to the bonnet after the Cv value of the diaphragm valve is adjusted to a target Cv value.
